(19) United States
(12) Patent Application Publication
(10) Pub. No.: US 2026/0139952 A1
(43) Pub. Date: May 21, 2026

(54) SYSTEMS AND METHODS FOR DATA COVERAGE OPTIMIZATION

(71) Applicant: Toyota Jidosha Kabushiki Kaisha, Aichi-ken (JP)

(72) Inventors: Jan Falkowski, Seattle, WA (US); James Peter Biagioni, Seattle, WA (US); Eitan Gilad Mendelowitz, Northampton, MA (US)

(73) Assignee: Toyota Jidosha Kabushiki Kaisha, Aichi-ken (JP)

(21) Appl. No.: 18/951,468

(22) Filed: Nov. 18, 2024

(51) Int. Cl. G01C 21/34; H04W 24/02

(52) U.S. Cl. CPC G01C 21/3461; H04W 24/02

(57) ABSTRACT

Embodiments are directed to systems and methods for data coverage optimization including a processor and a communication interface configured to communicate with one or more vehicles and a data transmission vehicle, the processor operable to predict, using a trained neutral network, whether one or more edge servers in an area are saturated, in response to a prediction of at least one saturated edge server, determine spots of data transmission delay in the area due to the saturated edge servers, and generate a route and instruct, using the communication interface, the data transmission vehicle to follow the route to the spots to coordinate with the edge servers to meet data requests from the one or more vehicles in the area.

### TECHNICAL FIELD

The present disclosure relates to systems and methods for data transmission, more specifically, to systems and methods for data transmission using edge servers.

### BACKGROUND

The performance of edge servers relies on how well they are spread out geographically. When user numbers vary, there's a chance that the need for data transmission might surpass the available bandwidth, leading to sluggish or inconsistent data transfers. Consequently, there's a need for deploying a data transmission solution, such as a rugged server, at the spot of saturated edge server(s) to meet the temporary surge in demand for data transmission.

### SUMMARY

The present disclosure provides systems and methods for data coverage optimization in data transmission using edge servers.

In one embodiment, a system for data coverage optimization includes a processor and a communication interface configured to communicate with one or more vehicles and a data transmission vehicle, the processor operable to predict, using a trained neutral network, whether one or more edge servers in an area are saturated, in response to a prediction of at least one saturated edge server, determine one or more spots of data transmission delay in the area due to the saturated edge servers, and generate a route and instruct, using the communication interface, the data transmission vehicle to follow the route to the spots to coordinate with the edge servers to meet data requests from the one or more vehicles in the area.

In another embodiment, a method for data coverage optimization includes predicting, using a trained neutral network, whether one or more edge servers in an area are saturated, in response to predicting that at least one edge server is saturated, determining one or more spots of data transmission delay in the area due to the saturated edge servers, and generating a route and instructing a data transmission vehicle through a communication interface to follow the route to the spots to coordinate with the edge servers to meet data requests from one or more vehicles in the area.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for data coverage optimization through route generation for a data transmission vehicle of the present disclosure, in accordance with one or more embodiments shown and described herewith;

FIG. 2 schematically depicts example components of the data coverage optimization system of the present disclosure, according to one or more embodiments shown and described herein;

FIG. 3 schematically depicts an example system for data coverage optimization through detour generation for a vehicle of the present disclosure, in accordance with one or more embodiments shown and described herewith;

FIG. 4 depicts a block diagram for predicting saturated edge servers using a trained neural network of the present disclosure, according to one or more embodiments shown and described herein; and

FIG. 5 depicts a flowchart for data coverage optimization of the present disclosure, according to one or more embodiments shown and described herein.

### DETAILED DESCRIPTION

The embodiments disclosed herein include systems and methods for route generation for data coverage optimization to meet the demand of data transmission around saturated edge servers and for detour generation for vehicles to avoid data transmission delay around saturated edge servers.

As used herein, the singular forms “a,” “an” and “the” include plural referents unless the context clearly dictates otherwise. Thus, for example, reference to “a” component includes aspects having two or more such components unless the context clearly indicates otherwise. Whenever possible, the same reference numerals will be used throughout the drawings to refer to the same or like parts.

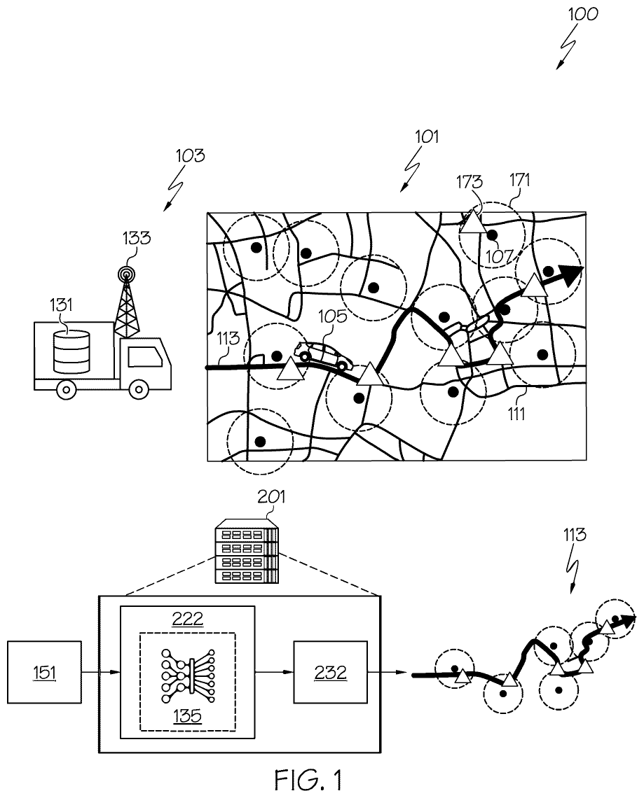

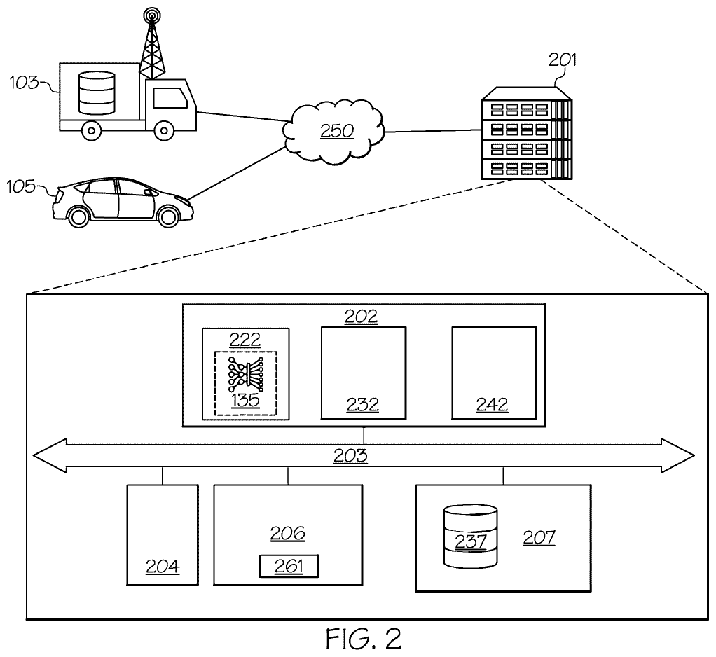

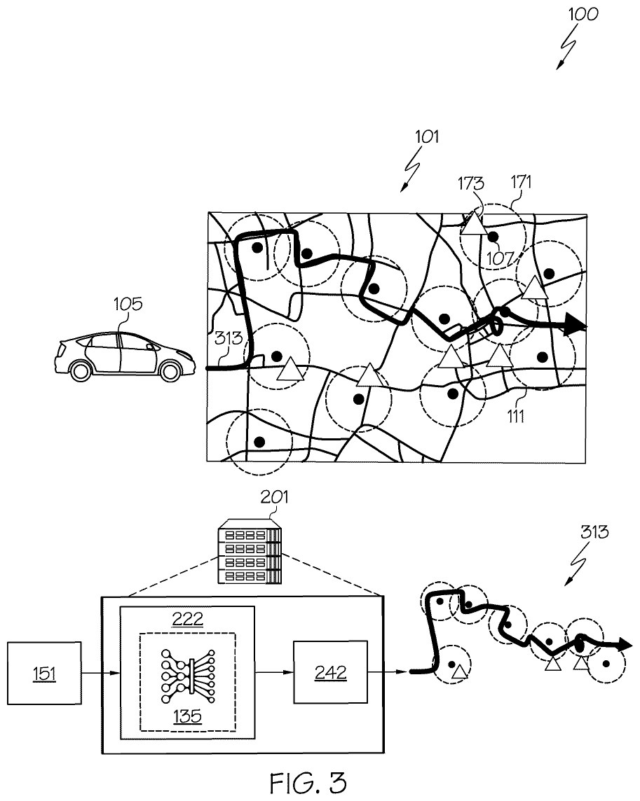

FIGS. 1 and 3 schematically depict an example data coverage optimization system 100. The data coverage optimization system 100 includes a controller 201 (as in FIG. 2). The controller 201 may include one or more modules 222, 232, and 242, and a communication interface 261 (as in FIG. 2). The data coverage optimization system 100 may include a plurality of vehicles, including one or more data transmission vehicles 103 and one or more data request vehicles 105. The communication interface 261 is configured to communicate with the vehicles 103 and 105. The data coverage optimization system 100 may further include one or more edge servers 107 in an area 101. The area 101 may include road network 111. The edge servers 107 may be located in the area 101 in a scattered manner, for example along the roads of the road network 111.

Each of the vehicles 103 and 105 may be an automobile or any other passenger or non-passenger vehicle such as, for example, a terrestrial, aquatic, and/or airborne vehicle. Each of the vehicles 103 and 105 may be an autonomous vehicle that navigates its environment with limited human input or without human input. Each of the vehicles 103 and 105 may move on a road of the road network 111 in the area 101. Each of the vehicles 103 and 105 may include actuators for driving the vehicle, such as a motor, an engine, or any other powertrain. The vehicles 103 and 105 may move on various surfaces, such as, without limitations, roads, highways, streets, expressway, bridges, tunnels, parking lots, garages, off-road trails, railroads, or any surfaces where the vehicles may operate. Each vehicle 105 may include a communication device, such as vehicle network interface hardware, operable to wirelessly communicate with each other, the data transmission vehicles 103, the edge servers 107, and the controller 201. Each vehicle 103 may include a communication device, such as data transmission interface hardware 133, operable to wirelessly communicate with the vehicles 105.

The edge servers 107 may be, without limitations, telematics servers, fleet management servers, connected car platforms, application servers, Internet of Things (IoTs) servers, or any server with the capability to transmit data with vehicles or other electronic devices. The edge server 107 may include a communication device similar to the data transmission interface hardware 133 of the vehicle 103 and communicate with the data request vehicles 105 via wireless communications 250 (as in FIG. 2). The edge servers 107 may include server communication devices, such as server network interface hardware, operable to communicate with the plurality of vehicles 103 and 105.

In embodiments, each data request vehicle 105 may send a request of data processing and data transmission to one or more of the edge servers 107 and/or one or more of the data transmission vehicle 103, regarding performing a task. Each of the data request vehicle 105 may include a network interface hardware and communicate with the edge servers 107, the data transmission vehicles 103, and the controller 201 via wireless communications 250.

In embodiments, each data transmission vehicle 103 may include a rugged server 131 and the data transmission interface hardware 133. The rugged server 131 may be configured to process the request of data processing and data transmission received from the data request vehicles 105. The data transmission interface hardware 133 may be configured to wirelessly communicate with the one or more data request vehicles 105 and the controller 201. In practice, the data transmission vehicles 103 may move on the roads of the road network 111 in the area 101 and provide data services to the data request vehicles 105 and/or other mobile devices near the data transmission vehicles 103 within a coverage radius of the data transmission vehicle 103.

In embodiments, each edge server 107 may receive the request of data processing and data transmission from and send processed data to the data request vehicles 105 or other mobile devices in coverage 171 around the edge server 107. The coverage 171 may have a coverage radius. The coverage 171 of each edge server 107 may depend on network topology, physical location, bandwidth capacity, signal strength, and the specific hardware capabilities of the edge server 107. In practice, a data request vehicle 105 or a mobile device may connect to the edge server 107 when the data request vehicle 105 or the mobile device is within the coverage 171. After establishing the connection between the data request vehicle 105 and one of the edge servers 107, the data request vehicle 105 may transfer data to the one of the edge servers 107 with a task and negotiate with the one of the edge servers 107 based on an expected computing time to fulfill the task and a computing power of the one of the edge server 107.

In embodiments, each edge server 107 may be saturated when the edge server 107 reaches its capacity limits in terms of processing power, memory, bandwidth, or storage. In some embodiments, one or more of the edge servers 107 in the area 101 may be saturated due to a sudden surge in user demands, such as from the data request vehicles 105. For example, during rush hours, more vehicles may travel along major roads of the road network 111 and high data requests may be sent to the edge servers 107 along the major roads, causing the edge servers 107 along the major roads to be saturated. The edge servers 107 may record the saturation and information related to the saturations, such as time of the saturation (hour, day, month, year), location of the edge server 107, data transmission delay spots 173 around the edge server 107, data requests from the data request vehicles 105, data quality of the requests and data received from the data request vehicles 105, weather in the area 101. The edge servers 107 may transfer the record of the saturation and related information to the controller 201 through the wireless communication 250.

In embodiments, when a data request vehicle 105 moves close to a saturated edge server 107, at one of the data transmission delay spots 173, the data request vehicle 105 may be denied to connect to the saturated edge server 107 or experience data transmission delay in communicating with the saturated edge server 107. The data request vehicle 105 may search for alternative edge servers 107 or data transmission vehicles 103 covering the position of the data request vehicle 105 and send the request for data transmission and data service to the alternative edge servers 107 or the data transmission vehicles 103.

The wireless communication 250 (in FIG. 2) may connect various components, the vehicles 103 and 105, and/or the edge server 107 of the data coverage optimization system 100 and allow signal transmission between the various components, the vehicles, and/or the edge server 107 of the data coverage optimization system 100. In some embodiments, the wireless communications 250 may facilitate the transmission of wireless signals, such as WiFi, Bluetooth®, Near Field Communication (NFC), and the like.

FIG. 2 schematically depicts example components of the controller 201 of the data coverage optimization system 100. The controller 201 may communicate with the data transmission vehicle 103 and the data request vehicle 105 through the wireless communication 250. While FIG. 2 depicts one data transmission vehicle 103, more than two data transmission vehicles 103 may be included in the data coverage optimization system 100. Similarly, while FIG. 2 depicts one data request vehicle 105, more than two data request vehicles 105 may be included in the data coverage optimization system 100.

The controller 201 may include one or more processors 204. Each of the one or more processors 204 may be any device capable of executing machine-readable and executable instructions. The instructions may be in the form of a machine-readable instruction set stored in data storage component 207 and/or the memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like.

Accordingly, the communication path 203 may be formed from any medium that is capable of transmitting a signal such as, for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The controller 201 may include one or more memory components 202 coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory components 202 may include an edge server saturation module 222, a route generation module 232, and a detour generation module 242. Each of the modules 222, 232, and 242 may include, but are not limited to, routines, subroutines, programs, objects, components, data structures, and the like for performing specific tasks or executing specific data types as will be described below. The data storage component 207 stores training data and historical data 237. The training data and historical data 237 may include historical data requests and historical data quality, weather, and hour in the area, real-time data transmission of the edge servers 107, properties, such as, without limitations, brands of the one or more data request vehicles 105 and associations between the one or more data request vehicles 105 and the edge servers 107, and distributions of the one or more vehicles sending the data in the area 101. The training data and historical data 237 may further include training data of sample edge servers, including the training data when the sample edge servers are saturated, associated with the data requests and data quality. The modules 222, 232, and 242 may also be stored in the data storage component 207 during operating or after operation.

The controller 201 may include network interface hardware 206 for communicatively coupling the controller 201 to external devices, such as the edge server 107, the vehicles 103 and 105. The network interface hardware 206 may include a communication interface 261 configured to communicate with the vehicles 103 and 105. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The communication interface 261 of the controller 201 may transmit its data to the data request vehicle 105 or the data transmission vehicle 103.

The controller 201 may be communicatively coupled to the data request vehicle 105 or the data transmission vehicle 103 by the wireless communication 250. In one embodiment, the wireless communication 250 may include one or more computer networks (e.g., a personal area network, a local area network, or a wide area network), cellular networks, satellite networks, and/or a global positioning system and combinations thereof. Accordingly, the controller 201 can be communicatively coupled to the wireless communication 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near-field communication protocols. Suitable cellular networks include, but are not limited to, technologies such as LTE, WiMAX, UMTS, CDMA, and GSM.

Referring to FIGS. 1, 2, and 4, the data coverage optimization system 100 may predict the saturation of one or more of the edge servers 107 in the area 101 at a specific time (hour, day, month, or year) and generate a route 113 for one or more of the data transmission vehicles 103 and a detour 313 for one or more of the data request vehicles 105.

The data coverage optimization system 100 may use the edge server saturation module 222, which includes a trained neural network 135, to predict, at a specific time (hour, day, month, or year), one or more of the saturated edge servers 107 in the area 101 and further determine the data transmission delay spots 173 near the saturated edge servers 107 in the area 101 based on the input data 151. The edge server saturation module 222 may generate a map 411 of the predicted saturated edge servers 107 and the associated spots 173. The generated map 411 may be fed to the module 232 to generate a route 113 for the data transmission vehicle 103 to move along the route 113 at the specific time to the data transmission delay spots 173 to coordinate with the saturated edge servers 107 to meet data requests from the one or more data request vehicles 105. The generated map 411 may be fed to the detour generation module 242 to generate a detour 313 at the specific time for one or more data request vehicles 105 to move along the detour 313 to avoid the saturated edge servers 107 and the data transmission delay spots 173.

In embodiments, the input data 151 may include historical data requests and historical data quality, weather, and hour in the area 101. The input data may include real-time data transmission of the edge servers 107. The input data may further include properties and distributions of the one or more data request vehicles 105 in the area 101. The properties of the data request vehicles 105 may include brands of the data request vehicles 105 and associations between the data request vehicles 105 and the edge servers 107. For example, some of the edge servers 107 may be associated with one or more brands of vehicles and may provide data services solely to the data request vehicles 105 of the brands or provide limited data service to the data request vehicles 105 of any non-associated brands. The input data 151 may be included in the training data and historical data 237 of the data storage component 207 of the controller 201.

For example, as illustrated in FIGS. 1, 3, and 4, the edge server saturation module 222, using the trained neural network 135, identifies six data transmission delay spots 173 associated with the saturated edge servers 107 at a specific time or in a span of a short period (such as rush hours). The six data transmission delay spots 173 are scattered within the area 101 in the map 411. Five of the data transmission delay spots 173 may be located along the main traffic roads in the road network 111 and one of the data transmission delay spots 173 (such as the one at the upper right of the map 411) may be located away from the main traffic roads in the road network 111.

As illustrated in FIG. 1, the route generation module 232, based on the location of the data transmission delay spots 173, may generate a route 113. The data coverage optimization system 100 may instruct the data transmission vehicle 103 to follow the route 113 to the data transmission delay spots 173 to coordinate with the saturated edge servers 107 to meet data transmission requests and demands. In some embodiments, the route 113 may not cover all the data transmission delay spots 173 due to limited resources. In the example of FIG. 1, the route 113 does not pass near one of the six data transmission delay spots 173 to the upper right of area 101. In such a case, in some embodiments, the data coverage optimization system 100 may instruct another data transmission vehicle 103 to the spot not covered by the generated route 113.

As illustrated in FIG. 3, the detour generation module 242, based on the location of the data transmission delay spots 173, may generate a detour 313. The data coverage optimization system 100 may inform the data request vehicles 105 that at or around the specific time, data transmission may be delayed at the locations of the data transmission delay spots 173 in the area 101. The data coverage optimization system 100 may provide to the data request vehicle 105 the detour 313 to avoid the data transmission delay spots 173 while still having sufficient data transmission coverage 171 along the detour 313 at or around the specific time. In some embodiments, the data coverage optimization system 100 may not be able to avoid all the data transmission delay spots 173 and may provide a detour 313 with minimum influence of any encountered data transmission delay spots 173 along the detour 313.

In some embodiments, the specific time (hour, day, month, or year) may be real-time or a selected time on a specific date. The data coverage optimization system 100 may determine that one or more of the edge servers 107 are expected to be saturated at a location in the area 101 at the selected time on the specific date and further determine that the location is one of the expected spots 173. The data coverage optimization system 100 may inform one or more data request vehicles 105 or one or more users of the expected data transmission delay at the location on the selected time. The data coverage optimization system 100 may further generate an expected route for the data transmission vehicle 103 to follow the expected route to the expected spots 173 to coordinate with the edge servers 107 to meet the data requests from the one or more data request vehicles 105 and/or to provide a detour 313 to the users to avoid the expected spots 173 of data transmission delay at the selected time.

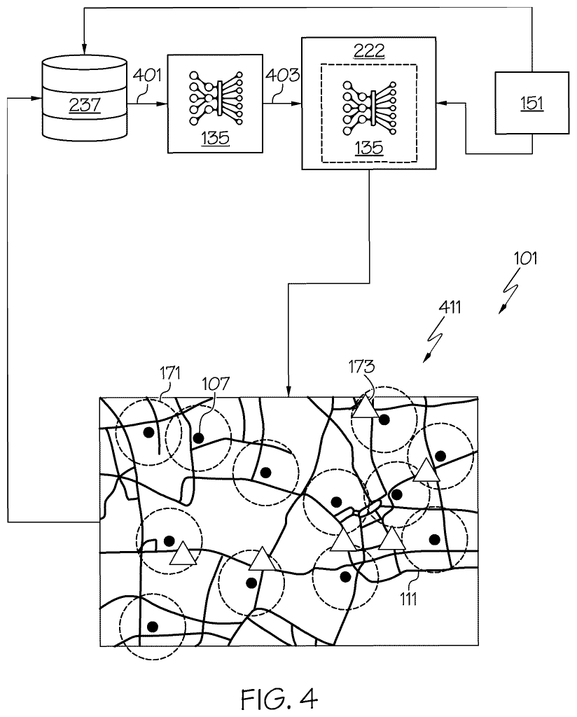

Referring to FIG. 4, a block diagram for predicting saturated edge servers 107 using a trained neural network 135 is depicted. In embodiments, the modules 222, 232, and 242 of the data coverage optimization system 100 may include one or more machine learning algorithms or neural networks, such as the neural network 135 of the edge server saturation module 222.

The modules 222, 232, and 242 may be trained and provided machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include generative artificial intelligence algorithms. The generative artificial intelligence algorithm may include a general adversarial network (GAN) that has two networks, a generator model and a discriminator model. The generative artificial intelligence algorithm may also be based on variation autoencoder (VAE) or transformer-based models.

The modules 222, 232, and 242 may be pre-trained using training data of the data coverage optimization, including ground-truth examples and scenarios where multiple entities (e.g. data request vehicles 105, data transmission vehicles 103, and edge servers 107) request and provide data transmission services while considering the locations of the entities, data transmission range and capacity, and factors (for example, without limitation, time of the day, environments, weather, etc.). The pre-training may include labeling the entities and desirable data coverage optimization results in the examples and scenarios and using one or more neural networks to learn to predict the desirable and undesirable data coverage results based on the training data. The pre-training may further include fine-tuning, evaluation, and testing steps. The one or more modules 222, 232, and 242 may be continuously trained using the real-world collected data to adapt to changing conditions and factors and improve the performance over time.

As illustrated in FIG. 4, the neural network 135 may be fed 401 with the training data and historical data 237 for training. The training data and historical data 237 may include historical data requests and historical data quality, weather, and hour in the area 101, real-time data transmission of the edge servers 107, properties, such as, without limitations, brands of the one or more data request vehicles 105 and associations between the one or more data request vehicles 105 and the edge servers 107, and distributions of the one or more vehicles sending the data in the area 101. The training data and historical data 237 may further include training data of sample edge servers, including the training data when the sample edge servers are saturated, associated with the data requests and data quality. The input data 151 including the real-time data transmission of the edge servers 107 and the generated map 411 may be continuously stored in the training data and historical data 237 and fed to the neural network 135 for continuous training and tuning. The trained neural network 135 may be continuously updated 403 through usage to further generate predicted saturation of the edge servers 107, the data transmission delay spots 173, and the map 411 of the predicted saturated edge servers 171 and the spots 173.

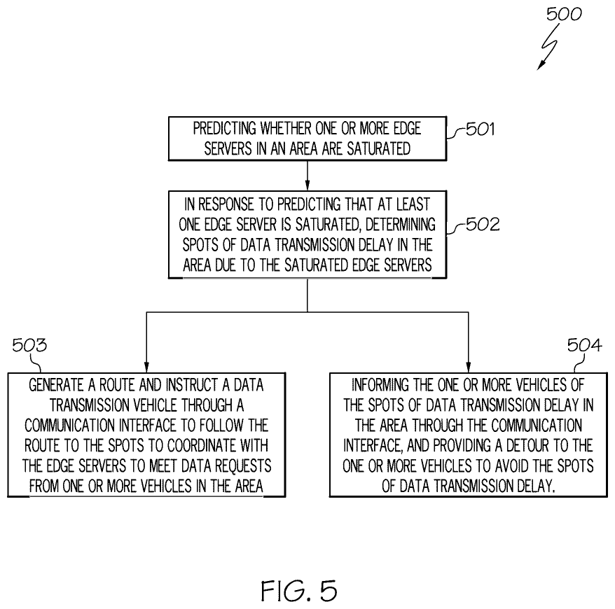

FIG. 5 depicts a flowchart for method 500 for data coverage optimization of the present disclosure. At block 501, the method 500 includes predicting, using the trained neural network 135, whether one or more edge servers 107 in the area 101 are saturated. By referring to FIGS. 1 through 4, in embodiments, the prediction is generated based on the input data 151 using the edge server saturation module 222, which includes the neural network 135.

In some embodiments, for the method 500, the prediction of the saturated edge servers 107 may be based on historical data requests and historical data quality, weather, hour in the area, real-time data transmission of the edge servers 107, properties and distributions of the one or more data request vehicles 105 sending the data in the area 101. The properties of the one or more data request vehicles 105 may include brands of the one or more data request vehicles 105 and associations between the one or more data request vehicles 105 and the edge servers 107.

Referring back to FIG. 5, at block 502, the method 500 includes in response to predicting that at least one edge server 107 is saturated, determining data transmission delay spots 173 in the area 101 due to the saturated edge servers 107. By referring to FIGS. 1 through 4, in embodiments, the edge server saturation module 222, which includes the neural network 135 may determine the data transmission delay spots 173 in the area 101. The data transmission delay spots 173 may be associated with the edge servers 107 to include in the map 411.

In embodiments, the neural network 135 may be trained with training data of sample edge servers stored in the data storage component 207. The sample edge servers may be associated with the data requests and data quality, wherein one or more of the sample edge servers are saturated. In some embodiments, the training data may further include historical data requests, historical data quality, historical hour, historical weather, and historical saturations of the edge servers in the area.

Referring back to FIG. 5, at block 503, the method 500 includes generating a route and instructing a data transmission vehicle through a communication interface to follow the route to the spots to coordinate with the edge servers to meet data requests from one or more vehicles in the area. By referring to FIG. 1, in embodiments, the route generation module 232 may generate a route 113 for the data transmission vehicle 103 to move along the route 113 to reach around the data transmission delay spots 173 to coordinate with the edge servers 107 to provide data services to the data request vehicles 105 around the data transmission delay spots 173.

Referring back to FIG. 5, at block 504, the method 500 includes informing the one or more data request vehicles 105 of the spots of data transmission delay in the area through the communication interface, and providing a detour to the one or more vehicles to avoid the spots of data transmission delay. By referring to FIG. 3, in embodiments, the data coverage optimization system 100 may inform the data request vehicles 105 of the data transmission delay spots 173 in the area 101. The detour generation module 242 may generate the detour 313 for the data request vehicles 105 to avoid the data transmission delay spots 173.

In some embodiments, the method 500 may further include determining whether one or more of the edge servers 107 are expected to be saturated at a location in the area 101 at a selected time on a specific date, in response to determining that one or more saturated edge servers 107 are expected at the selected time, generating expected spots 173 of data transmission delay in the area 101 based on the saturated edge servers 107, determining whether the location is one of the expected spots 173, and in response to determining the location is one of the data transmission delay spots 173, informing a user through the communication interface 261 of an expected data transmission delay at the location on the selected time.

In some embodiments, the method 500 may further include generating an expected route for the data transmission vehicle 103 to follow the expected route to the expected spots 173 to coordinate with the edge servers 107 to meet the data requests from the one or more data request vehicles 105, and providing a detour 313 to the user to avoid the expected spots of data transmission delay at the selected time.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for data coverage optimization comprising a processor and a communication interface configured to communicate with one or more vehicles and a data transmission vehicle, the processor operable to:
predict, using a trained neutral network, whether one or more edge servers in an area are saturated;
in response to a prediction of at least one saturated edge server, determine one or more spots of data transmission delay in the area due to the saturated edge servers; and
generate a route and instruct, using the communication interface, the data transmission vehicle to follow the route to the spots to coordinate with the edge servers to meet data requests from the one or more vehicles in the area.

2. The system of claim 1, wherein the processor is further operable to inform, using the communication interface, the one or more vehicles of the spots of data transmission delay in the area.

3. The system of claim 2, wherein the processor is further operable to provide a detour to the one or more vehicles to avoid the spots of data transmission delay.

4. The system of claim 1, wherein the prediction of the saturated edge servers is based on historical data requests and historical data quality, weather, and hour in the area.

5. The system of claim 4, wherein the prediction of the saturated edge servers is further based on real-time data transmission of the edge servers.

6. The system of claim 5, wherein the prediction of the saturated edge servers is further based on properties and distributions of the one or more vehicles sending the data in the area.

7. The system of claim 6, wherein the properties of the one or more vehicles comprise brands of the one or more vehicles and associations between the one or more vehicles and the edge servers.

8. The system of claim 1, wherein the neural network is trained with training data of sample edge servers associated with the data requests and data quality, wherein one or more of the sample edge servers are saturated.

9. The system of claim 8, wherein the training data further comprises historical data requests, historical data quality, historical hour, historical weather, and historical saturations of the edge servers in the area.

10. The system of claim 1, wherein the processor is further operable to:
determine whether one or more of the edge servers are expected to be saturated at a location in the area at a selected time on a specific date;
in response to determining that one or more saturated edge servers are expected at the selected time, generate expected spots of data transmission delay in the area based on the saturated edge servers;
determine whether the location is one of the expected spots; and
in response to determining the location is one of the spots, inform, using the communication interface, a user of an expected data transmission delay at the location on the selected time.

11. The system of claim 10, wherein the processor is further operable to generate an expected route for the data transmission vehicle to follow the expected route to the expected spots to coordinate with the edge servers to meet the data requests from the one or more vehicles.

12. The system of claim 10, wherein the processor is further operable to provide a detour to the user to avoid the expected spots of data transmission delay at the selected time.

13. A method for data coverage optimization comprising:
predicting, using a trained neutral network, whether one or more edge servers in an area are saturated;
in response to predicting that at least one edge server is saturated, determining one or more spots of data transmission delay in the area due to the saturated edge servers; and
generating a route and instructing a data transmission vehicle through a communication interface to follow the route to the spots to coordinate with the edge servers to meet data requests from one or more vehicles in the area.

14. The method of claim 13, wherein the method further comprises:
informing the one or more vehicles of the spots of data transmission delay in the area through the communication interface; and
providing a detour to the one or more vehicles to avoid the spots of data transmission delay.

15. The method of claim 13, wherein the prediction of the saturated edge servers is based on historical data requests and historical data quality, weather, hour in the area, real-time data transmission of the edge servers, properties and distributions of the one or more vehicles sending the data in the area.

16. The method of claim 15, wherein the properties of the one or more vehicles comprise brands of the one or more vehicles and associations between the one or more vehicles and the edge servers.

17. The method of claim 13, wherein the neural network is trained with training data of sample edge servers associated with the data requests and data quality, wherein one or more of the sample edge servers are saturated.

18. The method of claim 17, wherein the training data further comprises historical data requests, historical data quality, historical hour, historical weather, and historical saturations of the edge servers in the area.

19. The method of claim 13, wherein the method further comprises:
determining whether one or more of the edge servers are expected to be saturated at a location in the area at a selected time on a specific date;
in response to determining that one or more saturated edge servers are expected at the selected time, generating expected spots of data transmission delay in the area based on the saturated edge servers;
determining whether the location is one of the expected spots; and
in response to determining the location is one of the spots, informing a user through the communication interface of an expected data transmission delay at the location on the selected time.

20. The method of claim 19, wherein the method further comprises:
generating an expected route for the data transmission vehicle to follow the expected route to the expected spots to coordinate with the edge servers to meet the data requests from the one or more vehicles; and
providing a detour to the user to avoid the expected spots of data transmission delay at the selected time.
